(19) United States
(12) Patent Application Publication
(10) Pub. No.: US 2024/0291759 A1
(43) Pub. Date: Aug. 29, 2024

(54) MULTI-CLOUD CONTAINER COMMUNICATION

(71) Applicant: International Business Machines Corporation, Armonk, NY (US)

(72) Inventors: Rakesh Jain, San Jose, CA (US); Sandeep Gopisetty, Morgan Hill, CA (US)

(21) Appl. No.: 18/175,694

(22) Filed: Feb. 28, 2023

(51) Int. Cl. H04L 45/76; H04L 45/74

(52) U.S. Cl. CPC H04L 45/76; H04L 45/74

(57) ABSTRACT

One or more computer processors route one or more packets within an application that comprises a plurality of pods distributed in a multi-cloud environment. The one or more computer processors deploy one or more created proxies as one or more sidecar containers for each pod in the plurality of pods, wherein the sidecar containers run with an application container. The one or more computer processors apply a set of routing rules to each pod in the plurality of pods, wherein all traffic is routed between the one or more created proxies based on the set of routing rules.

### STATEMENT REGARDING PRIOR DISCLOSURES BY THE INVENTOR OR A JOINT INVENTOR

The following disclosure(s) are submitted under 35 U.S.C. 102(b)(1)(A):

(i) Canopy: A Multicloud, Multicluster Application Network for Kubernetes, Rakesk Jain and Sandeep Gopisetty,Apr. 1, 2022.

### BACKGROUND

The present invention relates generally to the field of containerization, and more particularly to container communication.

Multi-cloud is use of multiple cloud computing and storage services from different vendors in a single heterogeneous architecture to improve cloud infrastructure capabilities and cost. It also refers to the distribution of cloud assets, software, applications, etc. across several cloud-hosting environments. With a typical multi-cloud architecture utilizing two or more public clouds as well as multiple private clouds, a multi-cloud environment aims to eliminate the reliance on any single cloud provider and thus, vendor lock-in.

### SUMMARY

Embodiments of the present invention disclose a computer-implemented method, a computer program product, and a system. The computer-implemented method includes one or more computer processers routing one or more packets within an application that comprises a plurality of pods distributed in a multi-cloud environment. The one or more computer processors deploy one or more created proxies as one or more sidecar containers for each pod in the plurality of pods, wherein the sidecar containers run with an application container. The one or more computer processors apply a set of routing rules to each pod in the plurality of pods, wherein all traffic is routed between the one or more created proxies based on the set of routing rules.

### BRIEF DESCRIPTION OF THE DRAWINGS

Figure (i.e., FIG. 1 is a functional block diagram illustrating a computing environment, in accordance with an embodiment of the present invention;

FIG. 2 is a flowchart depicting operational steps of a program, on a computer within the computing environment of FIG. 1, for multi-cloud pod-to-pod communication, in accordance with an embodiment of the present invention;

FIG. 3 illustrates operational steps of a program within the computing environment of FIG. 1, in accordance with an embodiment of the present invention; and

FIG. 4 is a table, in accordance with an embodiment of the present invention.

### DETAILED DESCRIPTION

Organizations today are becoming increasingly more dependent on cloud infrastructure to drive innovation, increase business value and competitive differentiation. Cloud native applications, data, analytics, and infrastructure collectively serve as a platform for digital transformation of enterprise. Moreover, enterprise information technology (IT) environments are converging into hybrid and multi-cloud environments, where multi-cloud refers to a single organization or department sourcing multiple cloud services, public or private, from multiple suppliers to best suit business needs, budgets, and preferences, including, but not limited to, Infrastructure as a Service (IaaS), Platform as a Service (PaaS) and Software as a Service (SaaS). Similarly, hybrid cloud refers to an architecture utilizing two or more public clouds (i.e., multi-cloud) interconnected with private cloud or on-premises environments.

With the popularity and benefits of container orchestration platforms, organizations are employing cloud native architectures to host business critical applications. Most new applications are developed with cloud native architecture involving containers and managed with native orchestration platforms. Even legacy applications are being migrated to cloud native architecture as part of the journey to the cloud. The ease of management that orchestration platforms bring is accelerating multi-cloud adoption, where multi-cloud applications are required to be able to communicate among separated or distributed components. Multi-cloud or distributed applications still need to function as a unit despite deployment location (e.g., on-premises, a single cloud, or a plurality of clouds).

Traditional orchestration platforms or native orchestration platforms provide networks that are private, only allowing pod communication within the same cloud or cluster, preventing applications deployed in one cluster to communicate directly with the pods deployed in other clusters or clouds. Although some distributed applications utilize propriety communication protocols among distributed components (e.g., pods) to discover said components at runtime, said applications can only identify pods which are part of a local system or cloud and cannot communicate in a multi-cloud environment where networks are not exposed to the internet because of security reasons, IP address exhaustion issues, and cloud provider restrictions, etc., thus preventing required pod-to-pod connection. Furthermore, relying on traditional routing methods (i.e., service to pod connectivity) is deficient because there is no guarantee that traffic will arrive at an intended destination container or pod because the service can route traffic to any pod behind the service. In addition, traditional flat networks that utilize a container network interface (CNI) implementation to assist in pod communication are subject to IP address exhaustion, network security risks when exposing clusters to external networks, virtual private network requirements, and IP address restrictions.

Embodiments of the present invention allow for pod-to-pod communication over a plurality of varying clouds or clusters without dependency on underlying CNI implementation. Embodiments of the present invention control pod-to-pod communication spread over multiple clouds irrespective of native orchestration platform or CNI implementation and without the need for VPN connectivity between clusters. Embodiments of the present invention create and maintain an overlay network on top of a network provided by a native orchestration platform for pod-to-pod communication within a local cluster to one or more local/remote clusters. The one or more clusters can be in the same cloud provider, in different cloud providers, on-site, or any scenario containing multi-cloud and hybrid cloud environments. Embodiments of the present invention recognize that pod-to-pod connectivity across a plurality of clouds is required in many distributed database applications that need such connectivity to replicate data or shards to different pods (i.e., the application cluster nodes). Embodiments of the present invention only connect pods for components which need connectivity across clouds or clusters, providing additional security precautions. Embodiments of the present invention have no requirement for pod, service, and node IP address ranges in different clusters (e.g., same pod IP address ranges can exist in the two clusters). Embodiments of the present invention define routing rules to route traffic to local proxy servers and utilize local proxy servers to determine how to forward traffic to the destination pod ingress-local proxy servers that subsequently forward the traffic to the application container. Implementation of embodiments of the invention may take a variety of forms, and exemplary implementation details are discussed subsequently with reference to the Figures.

The present invention will now be described in detail with reference to the Figures.

FIG. 1 depicts computing environment 100 illustrating components of computer 101 in accordance with an illustrative embodiment of the present invention. It should be appreciated that FIG. 1 provides only an illustration of one implementation and does not imply any limitations with regard to the environments in which different embodiments may be implemented. Many modifications to the depicted environment may be made.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

Computing environment 100 contains an example of an environment for the execution of at least some of the computer code involved in performing the inventive methods, such as program 150. In addition to program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

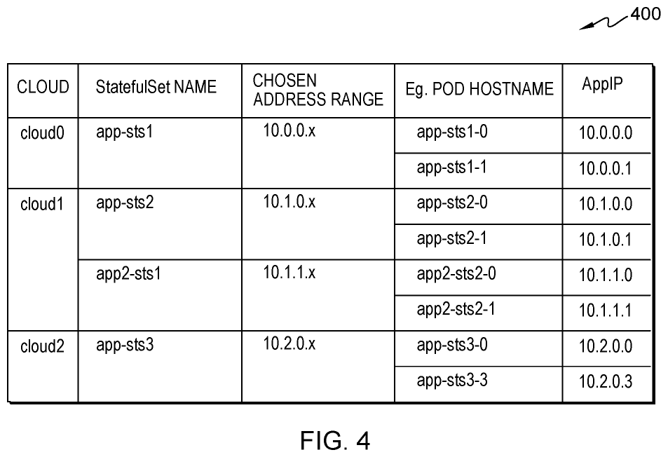

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 4. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip”. In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in program 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 (e.g., local cloud) is similar to public cloud 105 (e.g., remote cloud), except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

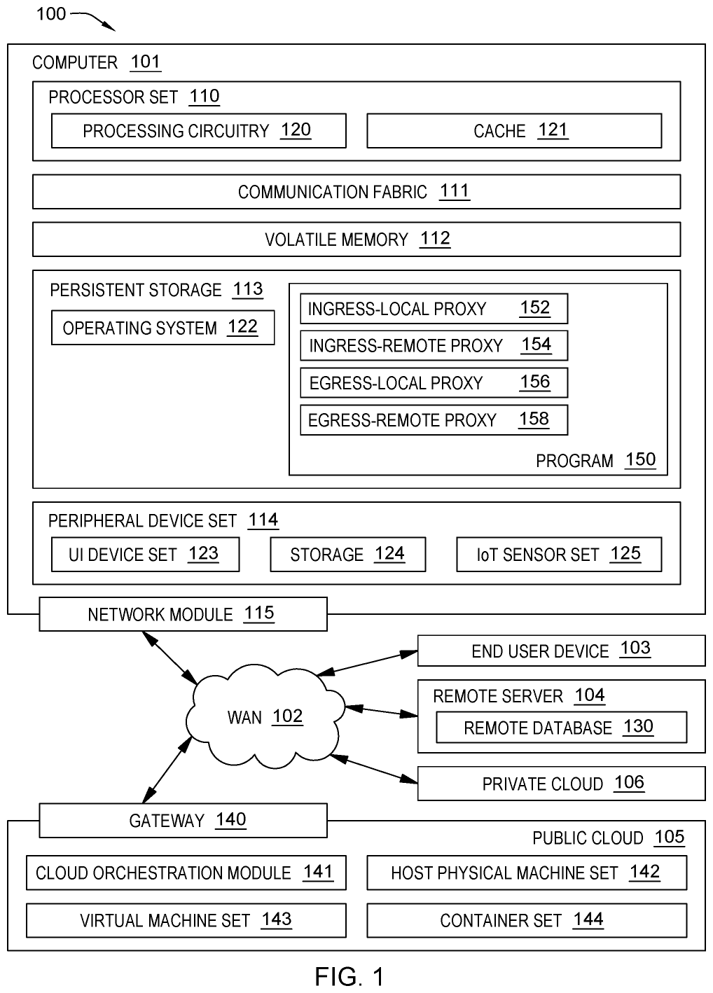

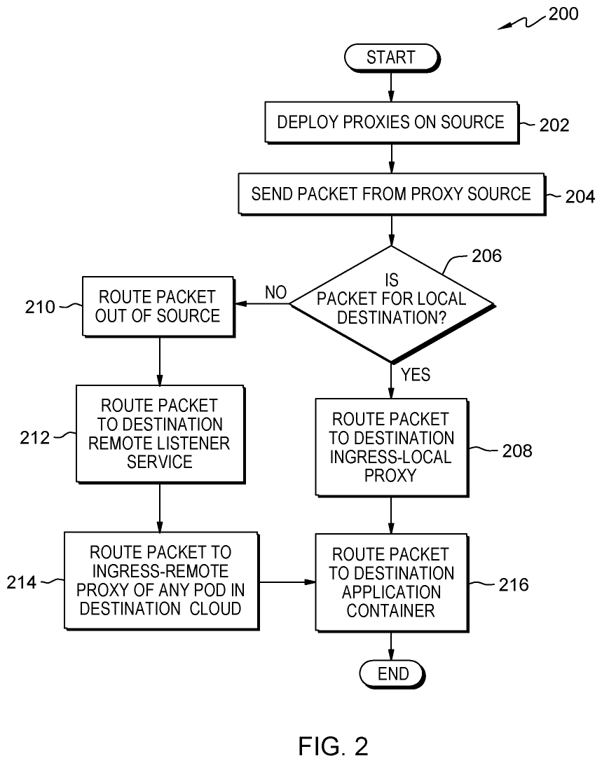

Program 150 is a program, a subprogram of a larger program, an application, a plurality of applications, or mobile application software, which functions multi-cloud pod-to-pod communication. In various embodiments, program 150 may implement the following steps: routing one or more packets within an application that comprises a plurality of pods distributed in a multi-cloud environment; deploying one or more created proxies as one or more sidecar containers for each pod in the plurality of pods, wherein the sidecar containers run with an application container; and applying a set of routing rules to each pod in the plurality of pods, wherein all traffic is routed between the one or more created proxies based on the set of routing rules. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over WAN 102. In various embodiments, client versions of program 150 resides on any other computing device (not depicted) within computing environment 100. Program 150 maintains, controls, and routes traffic to a plurality of client proxies including ingress-local proxy 152, ingress-remote proxy 154, egress-local proxy 156, and egress-remote proxy 158. Program 150 implements an instance of ingress-local proxy 152, ingress-remote proxy 154, egress-local proxy 156, and egress-remote proxy 158 for each pod within a multi-cloud environment. Program 150 is depicted and described in further detail with respect to FIG. 2.

Ingress-local proxy 152 routes traffic (i.e., packets) intended for a specific application and/or pod, routed by program 150 for pod-to-pod communication. Program 150 utilizes ingress-local proxy 152 to receive packets from one or more proxies from other pods. For example, instances of egress-local proxy 156 and ingress-remote proxy 154 send packets to ingress-local proxy 152 for final routing. When the packet reaches ingress-local proxy 152, ingress-local proxy 152 forwards the packet to the destination application container in the same pod. In an embodiment, program 150 configures ingress-local proxy 152 to accept a protocol associated with the incoming packets so that the AppIP (i.e., static internet protocol (IP) address generated by program 150 for pod-to-pod communication across multi-clouds) address of client (i.e., incoming packets) can be passed through.

Ingress-remote proxy 154 is utilized by program 150 to route packets from a remote cloud with an associated network load balancer on the destination cloud (i.e., cloud hosting the destination application and pod). Ingress-remote proxy 154 is utilized by program 150 to route packets from a remote cloud arriving to a network load balancer and service contained in the pod associated. Here, the service sends the packets to any one of the application pods in the local cloud. Responsive to one or more incoming packets, ingress-remote proxy 154 routes the packets to the correct destination pod in a local cloud. Ingress-remote proxy 154, uses the same approach as used by egress-local proxy 156, by constructing the fully qualified domain name (FQDN) of the pod, resolving the FQDN through a native DNS service and transporting the packets using the underlying network in the local cluster (i.e., destination cluster). Responsively, program 150 sends the packet to an instance of ingress-local proxy 152 associated with the destination pod and in turn program 150, utilizing ingress-local proxy 152, forwards the packets to the appropriate application container.

Egress-local proxy 156 routes packets destined to another pod within a local cloud. Egress-local proxy 156 utilizes a network provided by a traditional orchestration platform to send the packet to a destination pod with the destination IP address comprising a AppIP. Typically, a traditional orchestration platform (i.e., an underlying container orchestrater) would not be able to route packets to the AppIP but program 150 enables this communication. Here, the underlying network does not have enough network information or network access to route to the AppIP. Therefore, program 150 converts the destination AppIP address to a PodIP (i.e., IP address assigned to the pod from the underlying container orchestrator) address so that program 150 can use the underlying network to route traffic. Program 150 constructs the hostname of the destination pod using the AppIP address. For example, if a source is sending traffic to cloud 1 with a destination AppIP of 10.1.0.2, where the first three octets of the IP address represent a AppIP address range in cloud1 while the last octet of the IP address represents a pod ordinal. In further embodiment, program 150 identifies the name of a StatefulSet (i.e., a workload resource that manages the deployment and scaling of a set of pods) associated with the destination based on the hostname of the destination pod. Here, program 150 combines a name of the StatefulSet and the hostname to derive the FQDN of the destination. Responsive to the derived FQDN, program 150 utilizes the native DNS provided by the underlying orchestrater to derive the PodIP of the destination pod and route the packet to an instance of ingress-local proxy 152 associated with the destination.

Egress-remote proxy 158 routes packets according to pre-defined routing rules that determine if the packet is destined to a remote cloud. For example, the source pod is in cloud1, and the destination address, AppIP, starts with 10.2.x.x, associated with remote cloud2, then program 150 utilizes egress-remote proxy 158, to route the packets to the AppIP. Program 150 configures egress-remote proxy 158 to pass one or more packets to the network load balancer address of the remote cloud (i.e., destination). Responsive to the packets arriving to the network load balancer of the remote cloud, the packets are routed by the Remote Listener Service of the remote cloud to any available pod in cloud2, not necessarily the destination pod. When the packet reaches any pod, program 150 routes the packets to an associated instance of ingress-remote proxy 154 and program 150 utilizes Ingress-remote proxy 154, to direct the packets to the correct destination pod, as further explained in ingress-remote proxy 154.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

FIG. 2 depicts flowchart 200 illustrating operational steps of program 150 for multi-cloud pod-to-pod communication, in accordance with an embodiment of the present invention.

Program 150 deploys proxies on a source (step 202). In an embodiment, program 150 initiates responsive to the creation and deployment of a source which can include one or more pods and containers within a multi-cloud environment (i.e., distributed application). In this embodiment, program 150 creates and utilizes a StatefulSet to deploy and manage the pods, including within each pod creating an init container, sidecar container, and application container, as described below. In another embodiment, program 150 defines and implements an instance of ingress-local proxy 152, ingress-remote proxy 154, egress-local proxy 156, and egress-remote proxy 158, collectively hereinafter proxies, on the source. In further embodiment, program 150 deploys a headless service (i.e., Remote Listener Service) and a network load balancer for each cluster or cloud, as further detailed below. In another embodiment, program 150 utilizes a maintained StatefulSet associated with each cloud that manages the deployment and scaling of a set of pods along with managing the state for these pods.

In an embodiment, program 150 creates and implements a set of routing rules for each deployed pod as part of source initialization and deployment using the created init container. In this embodiment, program 150 routes all traffic is between one or more proxies based on the set of routing rules. In this embodiment, the init container runs through deployment and then exits. In an embodiment, program 150 utilizes the created init container for setting up IP routing and IP table rules for the application container. In a further embodiment, program 150 attaches the created sidecar container to the application container throughout life cycle of the application container and utilizes the sidecar for hosting the proxies for all inbound and outbound traffic of the application container. The sidecar container can serve application logic while enhancing application container capabilities. For example, logging, monitoring and/or networking can be done using one or more sidecar containers. In an embodiment, sidecar containers run as a separated containers within the pod, as separate processes, and therefore do not affect the performance of the associated application container. Program 150 utilizes a sidecar container for the purpose of serving proxy servers to handle inbound and outbound traffic of the application container.

Responsively, program 150 deploys the init container to generate a AppIP and routing rules. During pod deployment, program 150 generates the AppIP for a pod based on hostname of the pod. In an embodiment, the hostname is created from an associated StatefulSet name and a pod ordinal. In another embodiment, program 150 allocates IP address to the pod using the hostname. For example, for cloud1 with a network address range of 10.1.0.x, the pods receive IP addresses of 10.1.0.0, 10.1.0.1 and 10.1.0.2 respectively, whereas in cloud2, the pods receive IP addresses of 10.2.0.0, 10.2.0.1 and 10.2.0.2 respectively, wherein last octet of the IP address is derived from the pod ordinal. Responsive to the generated AppIP, program 150 labels the pod with the AppIP and sets routing rules for the pod. For example, program 150 adds the network 10.0.0.0/14 to a local network device (e.g., eth0) as a local route.

With the set routing rules program 150 creates a custom network for the pod with a unique IP address ranged network overlaying on top of a network provided by a native platform hosting one or more pods. Each of the pods deployed by program 150, using the StatefulSet, receive an IP address based on pod ordinal, and this IP address is in addition to the PodIP provided by the native platform. In addition to the hostname resolution, program 150 utilizes the StatefulSet as a headless service to control the domain of the pods. For example, program 150 adds an entry in an associated DNS server for each pod in the form of podhostname.headless servicename.namespace.svc.cluster domain'. In this example, every time the pod is created, program 150, utilizing the associated StatefulSet, updates the entry in DNS as the PodIP address provided to the pod by a native orchestrator. Given that the hostname of the pod is ‘sticky’, and there is a fixed pattern to associated DNS resolvable name.

Program 150 sends a packet from the proxied source (step 204). In an embodiment, program 150 monitors the deployed pods for all inbound traffic (e.g., packets) to and outbound traffic from the source (e.g., application container), where traffic is intercepted by the implemented proxies in step 202. In this embodiment, the application container and associated proxies are in the same pod managed by a native orchestration platform within a local cloud. Responsive to an outbound packet, program 150 determines if the outbound packet is intended (e.g., transmitted, conveyed, transferred, etc.) for a local or remote destination (i.e., cloud, pod, and/or container) utilizing the routing rules implemented during deployment in step 202.

If the packet is for a local destination (“yes” branch, decision block 206), then program 150 routes the packet to a destination ingress-local proxy (step 208). In an embodiment, if the destination is for a local cloud, program 150 forwards (e.g., routes) the, intercepted, packet to an attached instance of egress-local proxy 156 within the same pod as the source. Program 150 utilizes egress-local proxy 156 to derive a hostname of the local destination using the generated AppIP address from step 202. For example, the source is sending traffic to local cloud1 with a destination AppIP of 10.1.0.1, where the first three octets of the IP address represent AppIP address range in cloud1 while the last octet of the IP address represents a destination pod ordinal. In further embodiment, program 150 identifies a name of a StatefulSet associated with the destination based on the derived hostname of the destination. In an embodiment, program 150 combines the StatefulSet name and the hostname to derive the FQDN of the destination.

Responsive to a derived FQDN, program 150 utilizes native DNS services provided by a native orchestration platform to obtain a PodIP (i.e., IP address assigned to a pod from an underlying orchestrator) of the destination and use the underlying network to route the packet to an instance of ingress-local proxy 152 associated with the destination, which will forward the packet to the pod application container utilizing the target port, as detailed in step 216. Typically, the orchestration platform (e.g., an underlying container orchestrater) would not be able to route packets to the destination but program 150 enables this communication. Here, the underlying network does not have enough network information or network access to route directly using just the AppIP. Therefore, program 150 utilizes the derived FQDN and the native DNS provided by the underlying orchestrater to derive a PodIP of the destination pod and route the packet to an instance of ingress-local proxy 152 associated with the destination.

If the packet is for a remote destination (“no” branch, decision block 206), then program 150 routes the packet out of the source (step 210). In an embodiment, if the packet sent by the source (e.g., application container) is destined for an AppIP address associated with a remote cloud, program 150 forwards the packet to an instance of egress-remote proxy 158 associated with the source. Here, program 150 utilizes egress-remote proxy 158 to derive a hostname and subsequent FQDN of the destination utilizing the destination AppIP, as detailed in step 208. For example, the source is sending traffic to remote cloud2 with a destination AppIP of 10.2.0.1, where the first three octets of the IP address represent AppIP address range in cloud1 while the last octet of the IP address represents a destination pod ordinal.

Program 150 routes the packet to destination remote listener service (step 212). Responsive to the derived destination FQDN, program 150 routes the packet out of the source cloud utilizing egress-remote proxy 158 to a remote listener service associated with the destination cloud or cluster. In an embodiment, program 150 forwards the packet to an address of Remote Listener Service, which is a public IP address of an implemented Network Load Balancer of a service listening for incoming traffic for the destination (e.g., remote) cloud. In a further embodiment, the Remote Listener Service represents all instances of ingress-remote proxy 154 for all the pods in the destination cluster managed by given StatefulSet controller. In an embodiment, program 150 configures egress-remote proxy 158 to pass one or more packets to the network load balancer address of the remote cloud (i.e., destination cloud).

Program 150 routes the packet to an ingress-remote proxy of any pod in destination cloud (step 214). Responsive to a received packet, the destination Remote Listener Service routes the packet to any pod behind the Remote Listener Service, and the packet will be routed to the ingress-remote proxy server of said pod. Responsive to the packets arriving to the network load balancer of the destination cloud, the packets are routed by the Remote Listener Service of the destination cloud to any available pod in the destination cloud, not necessarily the destination pod. When the packet reaches any pod in the destination cloud, program 150 routes the packets to an associated instance of ingress-remote proxy 154. In an embodiment, program 150 utilizes ingress-remote proxy 154 to route the packet to the “correct” destination pod by converting the AppIP of the destination pod to a FQDN, thereby resolving an PodIP address from the native DNS service of the destination pod. Embodiments of the present invention implement the embodiments detailed above on each cloud in a multi-cloud environment to initiate pod-to-pod communication from any cloud to any destination pod whether located in one or more local clouds or one or more remote clouds.

Program 150 routes the packet to destination application container (step 216). Responsive to the packet arriving at an instance of ingress-remote proxy 154 or ingress-local proxy 152, program 150 routes the packet to the destination application container within the destination pod at a target port defined by the destination application container. In another embodiment, the packet is then utilized within application logic associated with the application container. In a further embodiment, program 150, responsively, continues to monitor all pods in all clouds for inbound or outbound traffic.

### Further Embodiments

Organizations today are more dependent on cloud infrastructure to drive innovation, business value and competitive differentiation. Cloud native applications, data, analytics, and cloud infrastructure collectively serve as the platform for digital transformation of enterprises. Moreover, enterprise IT environments are converging into hybrid and multi-cloud environments, where multi-cloud refers to a single organization or department sourcing multiple cloud services, public or private, from multiple suppliers to best suit business needs, budgets, and preferences, including, but not limited to, Infrastructure as a Service (IaaS), Platform as a Service (PaaS) and Software as a Service (SaaS). Similarly, hybrid cloud refers to an architecture which utilizes two or more public clouds (i.e., multi-cloud) interconnected with private cloud or on-premises environment.

Besides hybrid and multi-cloud, the other aspect is application architecture in the cloud. With the popularity and benefits of container orchestration platforms, organizations are employing cloud native architectures to host applications. The majority of newly applications are developed with cloud native architecture involving containers and managed with orchestration platforms. Even traditional applications are being migrated to cloud native architecture as part of the journey to the cloud. The ease of management that orchestration platforms bring is accelerating multi-cloud adoption, where multi-cloud applications are required to be able to communicate among separated components.

Embodiments of the present invention (i.e., program 150) focus on distributed applications which are managed using a container orchestration platform (i.e., native orchestration platform) and distributed across a plurality of clouds.

In container orchestration, a pod contains one or more containers, and the containers serve core application logic. Traditionally, pods are not accessed directly, but are accessed through a service, where a client accesses the service which in turn directs client traffic to one of the pods associated with the service. However, there are some distributed applications that contain communication protocols to communicate among distributed components while discovering these components at runtime. As part of this process, the applications identify pods and discover IP addresses and, responsively, commence communicating with the pod using an associated IP address while ignoring the service. Also, with this approach the applications reach directly to a specific pod, instead of going through the service and landing on a random pod backing that service. For such scenarios, pod-to-pod communication is required and while pod-to-pod communication is possible in local orchestration environments, issues arise when an application is distributed amongst a plurality of separated clusters. For example, if the application is deployed/distributed in two clusters (i.e., hybrid or multi-cloud environment), then it is not possible for pods from one cluster to communicate with pods in another cluster as networks in each cluster are private, and external clients cannot communicate with pods with an associated, private IP address (i.e., PodIP).

Embodiments of the present invention address the issue of pod-to-pod communication between a plurality of clusters address by creating a network exclusively for pod-to-pod communication allowing disparate cluster and cloud communication.

In container orchestration, a pod is the smallest deployable unit of compute. The pod is an environment for running containers and contains one or more containers which serve the application or part of it. The containers in a pod share the networking and storage resources, for example, an IP address is assigned at the pod level, meaning all the containers in a pod have the same IP address. Traditional use case prescribes a one container per pod policy. In an embodiment, a pod comprises an application and one or more sidecar containers, along with an init container. In this embodiment, a container orchestrator deploys and runs pods within an available worker node according to the required resource capacity. In this embodiment, a pod cannot be run across multiple nodes, but the environment can have multiple instances of the same pod running within the same node or separate nodes.

Init containers are temporary containers which run before application containers start. A pod can have one or more init containers, each init container runs to completion and then exits. In an embodiment, one init container must successfully complete before the next container can start. For example, if any init container in the pod fails, even after automatic retries, the pod deployment is marked failed by the container orchestrator. Init containers perform some initial setup for the application container. In an embodiment, an init container image contains tools and utilities which are not present in an application container due to the tools and utilities not being needed beyond initial setup or subject to security concerns and considerations. In an embodiment, the present invention utilizes init containers for the purpose of setting up IP route and IP table rules for the application container.

In an embodiment, a sidecar container is representative of a design pattern where the main application container is accompanied with another container (i.e., sidecar container), which has the same lifecycle as the application container. The sidecar container can serve application logic while enhancing application container capabilities. For example, logging, monitoring and/or networking can be done using one or more sidecar containers. In an embodiment, sidecar containers run as separated containers within the pod, as separate processes, and therefore do not affect the performance of the associated application container. The present invention utilizes a sidecar container for the purpose of serving proxy servers to handle inbound and outbound traffic of the application container.

In an embodiment, the pods are not individually managed, but are managed using a workload resource (e.g., StatefulSet) to make sure that the correct number (e.g., according to computational demand) and right kind of pods are running, to match a specified state. For example, a workload resource could include deployment, StatefulSet, replica set, job, etc. A controller (e.g., StatefulSet) for the resource manages replication of pods in the cluster, rollout, and automatic restart of the pods in case of failure, for example if a node fails, places the replacement pod on a different node. The specifications for creating pods are defined in a pod template comprising init containers and sidecar containers to run, if any, pod replicas, rollout strategy, readiness and liveness detection, environment variables, etc. Every time a pod restarts, the pod follows the pod template. In an embodiment, all pods deployed by a workload resource controller are of same type, meaning the pods contain the same containers and have the same lifecycle. For example, an application container is listening on port 5000, if an associated replica count is specified as 10 in the pod template, there will be 10 pods comprising the same content (i.e., containers) running in the cluster, each listening on port 5000. In an embodiment, the present invention utilizes the previous example for handling demand and load, for example, if there are more replicas of a pod, traffic to the application containers is routed through different pods to load balance and not overburden one or more pods. However, depending on application logic, in some cases when such multiple pods are deployed and the pods share a common configuration, the application containers can discover each other and start communicating with in an application native protocol.

In an embodiment, among these workload resources, the StatefulSet manages the deployment and scaling of a set of pods along with managing the state for these pods. In this embodiment, the StatefulSet provides guarantees about the ordering and uniqueness of the pods and maintains a sticky identity for each pod. The pods are created from the same specification but are not interchangeable: each having a persistent identifier that it maintains across rescheduling. Each pod in a StatefulSet derives a hostname from the name of the corresponding StatefulSet and an ordinal of the pod. For example, a pattern for a constructed hostname of a pod is “statefulset-name.ordinal”. In another example, the StatefulSet name in cloud1 is app-cloud1, then corresponding deployed pods will have a respective hostname in cloud1 as app-cloud1-0, app-cloud1-1, and app-cloud1-2, etc. Similarly, the StatefulSet named as app-cloud2 in cloud2 will produce pods with hostnames as app-cloud2-0, app-cloud2-1, app-cloud2-2, etc.

In addition to the hostname, embodiments of the present invention utilize the StatefulSet as a headless service to control the domain of the pods. For example, embodiments of the present invention make an entry in an associated DNS server for each pod in the form of “pod hostname.headless service_name.namespace.svc.cluster_domain”. In this example, every time the pod is created, the present invention updates the entry in DNS as the pod IP address provided to the pod by the container orchestrator. Given the fact that the hostname of the pod is sticky, and there is a fixed pattern to associated DNS resolvable name, embodiments of the present invention use the StatefulSet as a controller for the application.

Embodiments of the present invention implement networks where every pod receives an IP address and any pod on any worker can communicate with pods on any other worker node without network address translation (NAT). Embodiments of the present invention use a standard API often called Container Network Interface (CNI) allowing different networking implementations to plug into the container orchestrator. The present invention may call the API at any time a pod is being created or destroyed, which in turn allocates or releases the IP address to the pod and creates or deletes each pod network interface while connecting or disconnecting the pod from the rest of the network.

Depending on the implementation of the CNI plugin, the pods in traditional clusters may not be routable outside of the cluster. If the pod IP addresses are not routable outside the cluster, then for outgoing connections, traditional orchestrators use SNAT (Source Network Address Translation) to change the source IP address from the IP address of the pod to the IP address of the node hosting the pod, and reverse maps on return packets. Connections originating from outside of the cluster directly to the pod are not possible as the broader network does not have the information to route packets to the pod. If the pod IP addresses are routable outside the cluster, then for outgoing connections no SNAT is needed. Furthermore, connections from external networks directly to pod IP addresses are possible although requiring that the Pod IP addresses must be unique across external network(s). This scenario is difficult in multi-cloud environments where pod IP addresses cannot be exposed to the internet (i.e., external networks) because of security reasons, IP address exhaustion issues, CNI implementations, or cloud provider restrictions.

In an exemplary situation, a distributed application comprises containers which listen on TCP port 5000. The application consists of four pods (pod1-pod4) distributed across two clouds with pods (1-2) in cloud1 and pods (3-4) in cloud2. Each pod in the application is required to be able to communicate with every other pod in the application, for example pod1 should be able to communicate with pod2, pod3, and pod4 by the IP address of the target pod on the port number 5000. Likewise, every pod should be able to communicate directly to each of the other pods. The pods in cloud1 are managed by StatefulSet1 and the pods in cloud2 are managed by StatefulSet2. Deploying each StatefulSet in respective clouds deploys all pods of the application. The number of pods is not fixed, the StatefulSets can be scaled up or down to increase or decrease the number of pods in the application in each cloud as needed.

Embodiments of the present invention create a new network on top of an existing network provided by a traditional (i.e., incapable of pod-to-pod communication over multi-cloud environments) container orchestration platform. Embodiments of the present invention create the network programmatically as part of application StatefulSet deployment. Embodiments of the present invention select an IP address range for the application and for each cloud. In an embodiment, the present invention selects a sub range, such that the sub range does not overlap with the pod classless inter-domain routing (CIDR), service CIDR of the cluster, or VPC (Virtual Private Cloud) CIDR.

For example, embodiments of the present invention select an IP address range of 10.0.0.0/14 for a target distributed application, where for cloud1 the present invention selects 10.1.0.x and for cloud2 selects 10.2.0.x as the address range for pods. Here, application pods in cloud1 have up to 256 IP addresses and similarly in cloud2 also can have 256 IP addresses. In this example, the network generated and controlled by the present invention is called AppIP as opposed to the network (i.e., PodIP) provided by the traditional orchestration platform.

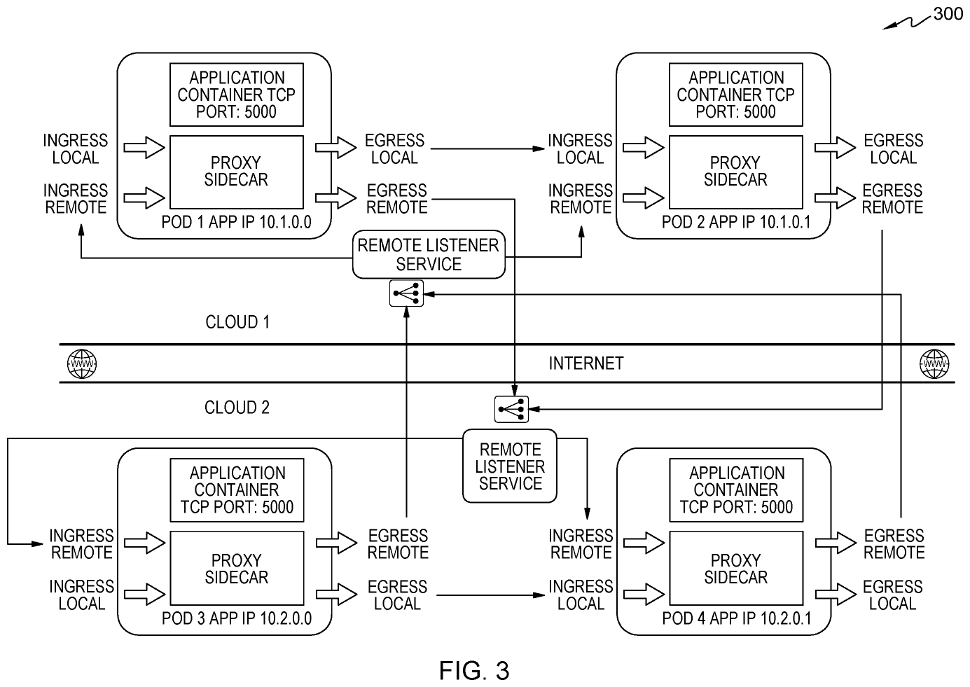

Embodiments of the present invention intercept, by a proxy container, all inbound and outbound traffic from the application container in the new network space within a pod. Before the application container starts, embodiments of the present invention generate an AppIP address for the application container generated from the hostname of the pod, which is derived from the name of the StatefulSet. In another embodiment, the present invention derives a pod hostname from the AppIP, which is utilized by the present invention to assist routing network traffic to a proxy container within the pod. Embodiments of the present invention implement four proxy servers within the proxy container in each pod to handle traffic from respective ingress local, ingress remote, egress local and egress remote, attached to each pod. The implemented proxy servers are explained in further detail in FIG. 3. Embodiments of the present invention implement a network load balancer to handle inbound traffic from one or more remote clouds, where the network load balancer contains endpoints defined as all the ingress-remote proxy servers contained within the proxy containers.

Embodiments of the present invention define routing rules to route traffic to local proxy servers and utilize the local proxy servers to determine how to forward traffic to the destination pod ingress-local proxy servers that subsequently forward the traffic to the application container.

FIG. 3 demonstrates how packets (i.e., traffic) are routed within a local cloud and to another (i.e., external) cloud. In an embodiment, responsive to an application container sending a packet to a destination address at target port, the present invention checks IP rules associated with the local container to verify that the destination AppIP is that of local cloud or remote cloud (i.e., external). In an embodiment, if the destination is for a local cloud, the present invention forwards the packet to an egress-local server associated with a proxy container within the same pod. Said egress-local proxy converts the destination AppIP to a fully qualified domain name (FQDN). Embodiments of the present invention utilizes this conversion so that the proxy can use native DNS services provided by traditional orchestration platforms. Here, the present invention utilizes the native DNS to obtain the PodIP of the destination pod and use the underlying network to route the packet to the ingress-local proxy server of the destination pod, which will forward the packet to the pod application container utilizing the target port.

In an embodiment, if the packet sent by application container is destined for an AppIP address associated with a remote cloud, the present invention forwards the packet to the pod egress-remote proxy and forwards the traffic to an address of Remote Listener Service, which is a public IP address of an implemented Network Load Balancer of a service listening for incoming traffic in the remote cloud. This service represents the ingress-remote proxy server of all the pods in the cluster managed by given StatefulSet controller. The packet can be sent to any pod behind the service, and the packet will be routed to the ingress-remote proxy server of the pod. The present invention utilizes the ingress-remote proxy to route the packet to the destination pod within local cloud and converts the AppIP of the destination pod to a FQDN, thereby resolving an PodIP address from the native DNS service of the destination pod. The present invention responsively utilizes the PodIP and underlying network to route the packet to the ingress-local proxy of the destination pod and forwards, utilizing the ingress-local proxy, the packet to the application container on the target port. Embodiments of the present invention implement the embodiments detailed above on each cloud in a multi-cloud environment to initiate pod-to-pod communication from any cloud to any destination pod whether located in one or more local clouds or one or more remote clouds.

To demonstrate the working of the present invention, embodiments of the present invention utilize an application container containing is a TCP echo server. When a client connects to the application container over TCP port 5000 and sends a message, the application echoes that message back to the client. Embodiments of the present invention deploy three pods in each cloud and connect from any pod in a cloud to any pod in any other cloud to test the communication. To implement the approach, for each cloud, the present invention creates a StatefulSet to deploy and manage the pods, including creating an init container, sidecar container and application container. In further embodiment, the present invention deploys a headless service and a network load balancer.

In an embodiment, the present invention creates and implements the routing rules for each pod as part of the initialization and deployment of a pod using an associated init container. In this embodiment, the init container runs through deployment and then exits. Here, the present invention applies the routing rules to all the containers in each pod. In a further embodiment, a sidecar container accompanies the application container throughout life cycle of the application container and is responsible for hosting the proxies for all inbound and outbound traffic of an application container. Responsively, the present invention deploys the StatefulSet where the init container is utilized by the present invention to generate the AppIP and routing rules. During pod deployment, the present invention generates a AppIP for the pod based on hostname of the pod. In an embodiment, the hostname is created from StatefulSet name and pod ordinal (e.g., pods in cloud1 receive hostnames including gcp-0, gcp-1, gcp-2 and in cloud2, excloud-0, excloud-1, excloud-2). In another embodiment, the present invention allocates IP address to each pod using the hostname. For example, for cloud1 with a network address of 10.1.0.x, the pods get IP addresses of 10.1.0.0, 10.1.0.1 and 10.1.0.2 respectively, whereas in cloud2, the pods get IP addresses of 10.2.0.0, 10.2.0.1 and 10.2.0.2 respectively, where last octet is derived from the pod ordinal.

Responsive to the generated AppIP, the present invention labels the pod with the AppIP and sets routing rules for the pod. For example, the present invention adds the network 10.0.0.0/14 to the local network device (e.g., eth0) as a local route. In a further example, the present invention adds an iptables route to the NAT table to trigger if the destination IP address is the same as the source, let traffic flow without assistance to local pod. Another example route, if the destination IP address is for local cloud only, the present invention changes the destination port to that of egress-local on local pod, for example in cloud1, if the destination is 10.1.0.x, the destination is a local cloud is for local cloud, and if the destination is 10.2.0.x, the destination is a remote cloud. Another example route, if the destination IP address is associated with a remote cloud, the present invention changes the destination port to that of egress-remote on the local pod.

With these rules the present invention creates a custom network for the application with a unique IP address ranged network overlaying on top of a network provided by the native platform. Each of the application pods deployed by the present invention using a controlled StatefulSet receive an IP address based on pod ordinal, and this IP address is in addition to the PodIP provided by the native platform. The present invention binds to this IP address and communicates using it. In an embodiment, unlike the PodIP, the AppIP address is fixed for the pods, which that each pod will always get the same AppIP address even after restarts because the StatefulSet guarantees the same hostname derived from the AppIP address.

In another embodiment, the present invention creates a sidecar container for the proxy servers. In an example, the present invention utilizes reverse proxy for the proxies that accompany every application container. Two proxies are for handling egress traffic (one for local egress and one for remote egress) and two for handling ingress traffic (one for local ingress and one for remote ingress).

In yet another embodiment, the present invention deploys a headless service in each cloud backed by all pods deployed using the StatefulSet. This service allows pod information an entry in the DNS service provided by the native platform. To support communication across the clouds for application pods, the present invention creates a Remote Listener Service of network load balancer type allowing TCP/UDP traffic. This service points to an instance of ingress-remote proxy in respective clouds.

Egress-local routes packets destined to another pod within a local cloud. Egress-local utilizes a network provided by a traditional orchestration platform to send the packet to a destination pod with the destination IP address comprising a AppIP. Typically, a traditional orchestration platform would not be able to route packets to the AppIP, but the present invention enables this communication. Here, the underlying network does not have enough network information or network access to route to the AppIP. Therefore, the present invention converts the destination AppIP address to a PodIP (i.e., IP address assigned to the pod from the underlying container orchestrator) address so that the present invention can use the underlying network to route traffic. The present invention constructs the hostname of the destination pod using the AppIP address. For example, if a source container is sending traffic to cloud1 with a destination AppIP of 10.1.0.2, where the first three octets of the IP address represent a AppIP address range in cloud1 while last octet represents a pod ordinal. In further embodiment, the present invention identifies the name of a StatefulSet associated with the destination based on the hostname of the destination pod. Here, the present invention combines the StatefulSet name and the hostname to derive the FQDN of the destination. Responsive to the derived FQDN, the present invention utilizes the native DNS provided by the underlying orchestrater to derive the PodIP of the destination pod and route the packet to an instance of ingress-local associated with the destination.

Ingress-local is the destination of one or more packets (i.e., traffic) routed by the present invention for pod-to-pod communication. The present invention utilizes ingress-local to receive packets from one or more proxies from other pods within a local cloud. For example, instances of egress-local and ingress-remote send packets to ingress-local for final routing. When the packet reaches ingress-local, ingress-local forwards the packet to the destination application container in the same pod. In an embodiment, the present invention configures ingress-local to accept a protocol associated with the incoming packets so that the AppIP (i.e., IP generated by the present invention for pod-to-pod communication) address of client (i.e., incoming packets) can be passed through.

Egress-remote routes packets according to pre-defined routing rules that determine if the packet is destined to a remote cloud. For example, the source pod is in cloud1, and the destination address, AppIP, starts with 10.2.x.x, associated with remote cloud2, then the present invention utilizes egress-remote, to route the packets to the AppIP. The present invention configures egress-remote to pass one or more packets to the network load balancer address of the remote cloud (i.e., destination). Responsive to the packets arriving to the network load balancer of the remote cloud, the packets are routed by a Remote Listener Service contained in the remote cloud to any available pod in cloud2, not necessarily the destination pod. When the packet reaches any pod, the present invention routes the packets to an associated instance of ingress-remote, the present invention, utilizes ingress-remote, to direct the packets to the correct destination pod, as further explained in ingress-remote.

Ingress-remote is utilized by the present invention to route packets from a remote cloud to a network load balancer on the destination cloud (i.e., cloud hosting the destination application and pod). Ingress-remote is utilized by the present invention responsive to packets from a remote cloud arriving to a network load balancer contained in a pod associated with ingress-remote. Here, the service sends the packets to one of the application pods in the local cloud. Responsive to one or more incoming packets, ingress-remote routes the packets to destination pod in a local cloud. Ingress-remote, uses the same approach as used by egress-local, constructs the fully qualified domain name (FQDN) of the pod, resolves the FQDN through a native DNS service and transporting the packets using the underlying network in the local cluster (i.e., destination cluster). Responsively, the present invention sends the packet to an instance of ingress-local associated with the destination pod and in turn the present invention, utilizing ingress-local, forwards the packets over to the application container.

The present invention describes a creation of an overlay network on top of a network provided by an orchestration platform for pod-to-pod communication within a local cluster to one or more local/remote clusters. The one or more clusters can be in the same cloud provider, in different cloud providers, on-site, or any scenario containing multi-cloud and hybrid cloud environments. Pod-to-pod connectivity across a plurality of clouds is required in many distributed database applications that need such connectivity to replicate data or shards to different pods (i.e., the application cluster nodes).

FIG. 3 depicts example 300, in accordance with an illustrative embodiment of the present invention. Example 300 is an illustrative embodiment demonstrating a packet traversing (i.e., routing) from origin pod (i.e., source pod) to destination pod (i.e., destination application container at target port). Example 300 illustrates a distributed application comprises containers listening on TCP port 5000. The distributed application consists of four pods (pod1-pod4) distributed across two clouds with pods (1-2) in cloud1 and pods (3-4) in cloud2. Each pod in the distributed application is required to be able to communicate with every other pod in the application, for example pod1 should be able to communicate with pod2, pod3, and pod4 on the port number 5000. Likewise, every pod should be able to communicate directly to each of the other pods. The pods in cloud1 are managed by StatefulSet1 and the pods in cloud2 are managed by StatefulSet2. Deploying each StatefulSet in respective clouds deploys all pods of the application. The number of pods is not fixed, the StatefulSets can scale up or down to increase or decrease the number of pods in the application as needed. A packet originating from pod1 destined for pod4 using AppIP will first go to pod1 egress-remote proxy. From there program 150 forwards the packet to the public IP address of cloud2 network load balancer and port. The load balancer is backed by Remote Listener Service which represents ingress-remote proxy of the pods. Alternatively, the packet lands on pod3 of cloud2. Here the ingress-remote proxy will resolve, as described in flowchart 200, the PodIP of the destination pod and use the underlying network to forward the packet to the destination pod4, to pod4 ingress-local proxy, which in turn forwards the packet to the application container port 5000 in the same pod.

FIG. 4 depicts table 400, in accordance with an illustrative embodiment of the present invention. Table 400 contains a plurality of examples of AppIP based on cloud and stateful Set.

What is claimed is:

1. A computer-implemented method comprising:
routing, by one or more computer processors, one or more packets within an application that comprises a plurality of pods distributed in a multi-cloud environment, comprising:
deploying, by one or more computer processors, one or more created proxies as one or more sidecar containers for each pod in the plurality of pods, wherein the sidecar containers run with an application container; and
applying, by one or more computer processors, a set of routing rules to each pod in the plurality of pods, wherein all traffic is routed between the one or more created proxies based on the set of routing rules.

2. The computer-implemented method of claim 1, wherein the one or more created proxies comprise an ingress-local proxy, ingress-remote proxy, egress-local proxy, and egress-remote proxy.

3. The computer-implemented method of claim 2, further comprising:
responsive to a packet, determining, by one or more computer processors, a destination associated with the packet, wherein the packet is sent from a source pod to a destination pod in the multi-cloud environment; and
deriving, by one or more computer processors, a fully qualified domain name (FQDN) associated with the destination using a generated multi-cloud static internet protocol (IP) address.

4. The computer-implemented method of claim 3, further comprising:
responsive to determining that the destination is associated with a local cloud, routing, by one or more computer processors, the packet to the egress-local proxy within the source pod;
sending, one or more computer processors, the packet to the ingress-local proxy within the destination pod using the derived FQDN; and
routing, one or more computer processors, the packet from the ingress-local proxy to a destination application container within the destination pod at a target port.

5. The computer-implemented method of claim 3, further comprising:
responsive to determining that the destination is associated with a remote cloud, routing, by one or more computer processors, the packet to the egress-remote proxy within the source pod, wherein the packet is routed from the egress-remote proxy to a remote listener service of all the pods in the remote cloud;
routing, by one or more computer processors, the packet from the remote listener service to any pod in the remote cloud;
routing, by one or more computer processors, the packet from any pod in the remote cloud to the ingress-remote proxy in the destination pod using the derived FQDN; and
routing, one or more computer processors, the packet from the ingress-remote proxy in the destination pod to a destination application container within the destination pod at a target port.

6. The computer-implemented method of claim 3, wherein a first three octets of the multi-cloud static IP address represents an address range in a cloud associated with the destination and a last three octets of the multi-cloud static IP address represent a pod ordinal associated with the destination.

7. The computer-implemented method of claim 5, wherein the remote listener service is a public IP address of a network load balancer of the remote listener service for incoming traffic in the remote cloud.

8. A computer program product comprising:
one or more computer readable storage media having computer-readable program instructions stored on the one or more computer readable storage media, said program instructions executes a computer-implemented method comprising steps of:
routing one or more packets within an application that comprises a plurality of pods distributed in a multi-cloud environment, comprising:
deploying one or more created proxies as one or more sidecar containers for each pod in the plurality of pods, wherein the sidecar containers run with an application container; and
applying a set of routing rules to each pod in the plurality of pods, wherein all traffic is routed between the one or more created proxies based on the set of routing rules.

9. The computer program product of claim 8, wherein the one or more created proxies comprise an ingress-local proxy, ingress-remote proxy, egress-local proxy, and egress-remote proxy.

10. The computer program product of claim 9, wherein the program instructions, stored on the one or more computer readable storage media, further comprise the steps of:
responsive to a packet, determining a destination associated with the packet, wherein the packet is sent from a source pod to a destination pod in the multi-cloud environment; and
deriving a fully qualified domain name (FQDN) associated with the destination using a generated multi-cloud static internet protocol (IP) address.

11. The computer program product of claim 10, wherein the program instructions, stored on the one or more computer readable storage media, further comprise the steps of:
responsive to determining that the destination is associated with a local cloud, routing the packet to the egress-local proxy within the source pod;
sending the packet to the ingress-local proxy within the destination pod using the derived FQDN; and
routing the packet from the ingress-local proxy to a destination application container within the destination pod at a target port.

12. The computer program product of claim 11, wherein the program instructions, stored on the one or more computer readable storage media, further comprise the steps of:
responsive to determining that the destination is associated with a remote cloud, routing the packet to the egress-remote proxy within the source pod, wherein the packet is routed from the egress-remote proxy to a remote listener service of all the pods in the remote cloud;
routing the packet from the remote listener service to any pod in the remote cloud;
routing the packet from any pod in the remote cloud to the ingress-remote proxy in the destination pod using the derived FQDN; and
routing the packet from the ingress-remote proxy in the destination pod to a destination application container within the destination pod at a target port.

13. The computer program product of claim 11, wherein a first three octets of the multi-cloud static IP address represents an address range in a cloud associated with the destination and a last three octets of the multi-cloud static IP address represent a pod ordinal associated with the destination.

14. The computer program product of claim 12, wherein the remote listener service is a public IP address of a network load balancer of the remote listener service for incoming traffic in the remote cloud.

15. A computer system comprising:
one or more computer processors;
one or more computer readable storage media having computer readable program instructions stored on the one or more computer readable storage media for execution by at least one of the one or more processors, the stored program instructions execute a computer-implemented method comprising steps of:
routing one or more packets within an application that comprises a plurality of pods distributed in a multi-cloud environment, comprising:
deploying one or more created proxies as one or more sidecar containers for each pod in the plurality of pods, wherein the sidecar containers run with an application container; and
applying a set of routing rules to each pod in the plurality of pods, wherein all traffic is routed between the one or more created proxies based on the set of routing rules.

16. The computer system of claim 15, wherein the one or more created proxies comprise an ingress-local proxy, ingress-remote proxy, egress-local proxy, and egress-remote proxy.

17. The computer system of claim 16, wherein the program instructions, stored on the one or more computer readable storage media, further comprise the steps of:
responsive to a packet, determining a destination associated with the packet, wherein the packet is sent from a source pod to a destination pod in the multi-cloud environment; and
deriving a fully qualified domain name (FQDN) associated with the destination using a generated multi-cloud static internet protocol (IP) address.

18. The computer system of claim 17, wherein the program instructions, stored on the one or more computer readable storage media, further comprise the steps of:
responsive to determining that the destination is associated with a local cloud, routing the packet to the egress-local proxy within the source pod;
sending the packet to the ingress-local proxy within the destination pod using the derived FQDN; and
routing the packet from the ingress-local proxy to a destination application container within the destination pod at a target port.

19. The computer system of claim 18, wherein the program instructions, stored on the one or more computer readable storage media, further comprise the steps of:
responsive to determining that the destination is associated with a remote cloud, routing the packet to the egress-remote proxy within the source pod, wherein the packet is routed from the egress-remote proxy to a remote listener service of all the pods in the remote cloud;
routing the packet from the remote listener service to any pod in the remote cloud;
routing the packet from any pod in the remote cloud to the ingress-remote proxy in the destination pod using the derived FQDN; and
routing the packet from the ingress-remote proxy in the destination pod to a destination application container within the destination pod at a target port.

20. The computer system of claim 18, wherein a first three octets of the multi-cloud static IP address represents an address range in a cloud associated with the destination and a last three octets of the multi-cloud static IP address represent a pod ordinal associated with the destination.
